(19) United States
(12) Patent Application Publication
(10) Pub. No.: US 2007/0078653 A1
(43) Pub. Date: Apr. 5, 2007

(54) Language model compression

(75) Inventor: Jesper Olsen, Helsinki (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/243,447

(22) Filed: Oct. 3, 2005

(51) Int. Cl. G10L 15/00

(52) U.S. Cl. 704/240

(57) ABSTRACT

A method for compressing a language model that comprises a plurality of N-grams and associated N-gram probabilities. The method comprises forming at least one group of N-grams from the plurality of N-grams; sorting N-gram probabilities associated with the N-grams of the at least one group of N-grams; and determining a compressed representation of the sorted N-gram probabilities. The at least one group of N-grams may be formed from N-grams of the plurality of N-grams that are conditioned on the same (N−1)-tuple of preceding words. The compressed representation of the sorted N-gram probabilities may be a sampled representation of the sorted N-gram probabilities or may comprise an index into a codebook. The invention further relates to an according computer program product and device, to a storage medium for at least partially storing a language model, and to a device for processing data at least partially based on a language model.

### FIELD OF THE INVENTION

This invention relates to a method for compressing a language model that comprises a plurality of N-grams and associated N-gram probabilities. The invention further relates to an according computer program product and device, to a storage medium for at least partially storing a language model, and to a device for processing data at least partially based on a language model.

### BACKGROUND OF THE INVENTION

In a variety of language-related applications, such as for instance speech recognition based on spoken utterances or handwriting recognition based on handwritten samples of texts, a recognition unit has to be provided with a language model that describes the possible sentences that can be recognized. At one extreme case, this language model can be a so-called “loop grammar”, which specifies a vocabulary, but does not put any constraints on the number of words in a sentence or the order in which they may appear. A loop grammar is generally unsuitable for large vocabulary recognition of natural language, e.g. Short Message Service (SMS) messages or email messages, because speech/handwriting modeling alone is not precise enough to allow the speech/handwriting to be converted to text without errors. A more constraining language model is needed for this.

One of the most popular language models for recognition of natural language is the N-gram model, which models the probability of a sentence as a product of the probability of the individual words in the sentence by taking into account only the (N−1)-tuple of preceding words. Typical values for N are 1, 2 and 3, and the corresponding N-grams are denoted as unigrams, bigrams and trigrams, respectively. As an example, for a bigram model (N=2), the probability P(S) of a sentence S consisting of four words w₁, W₂, W₃ and W₄, i.e.
S=w₁w₂w₃w₄
is calculated as
P(S)=P(w₁|<s>)·P(w₂|w₁)·P(w₃|w₂)·P(w₄|w₃)·P(</s>|w₄)

Wherein <s>and </s>are symbols which mark respectively the beginning and the end of the utterance, and wherein P(wᵢ|wᵢ₋₁) is the bigram probability associated with bigram (wᵢ₋₁, wᵢ), i.e. the conditional probability that word wᵢ follows word wᵢ₋₁.

For a trigram (wᵢ₋₂,wᵢ₋₁,wᵢ), the corresponding trigram probability is then given as P(wᵢ|wᵢ₋₂ wᵢ₋₁). The (N−1)-tuple of preceding words is often denoted as “history” h, so that N-grams can be more conveniently written as (h,w), and N-gram probabilities can be more conveniently written as P(w|h), with w denoting the last word of the N words of an N-gram, and h denoting the N−1 first words of the N-gram.

In general, only a finite number of N-grams (h,w) have conditional N-gram probabilities P(w|h) explicitly represented in the language model. The remaining N-grams are assigned a probability by the recursive backoff rule
P(w|h)=α(h)·P(w|h′),

Where h′ is the history h truncated by the first word (the one most distant from w), and α(h) is a backoff weight associated with history h, determined so that Σ_{w}P(w|h)=1.

N-gram language models are usually trained on text corpora. Therein, typically millions of words of training text is required in order to train a good language model for even a limited domain (e.g. a domain for SMS messages). The size of an N-gram model tends to be proportional to the size of the text corpora on which it has been trained. For bi- and tri-gram models trained on tens or hundreds of millions of words, this typically means that the size of the language model amounts to megabytes. For speech and handwriting recognition in general, and in particular for speech and handwriting recognition in embedded devices such as mobile terminals or personal digital assistants, to name but a few, the memory available for the recognition unit limits the size of the language models that can be deployed.

To reduce the size of an N-gram language model, the following approaches have been proposed:
Pruning
   Document “Entropy-based Pruning of Backoff Language Models” by Stolcke, A. in Proceedings DARPA Broadcast News Transcription and Understanding Workshop 1998, Lansdowne, Virginia, USA, Feb. 8-11, 1998 proposes that the size of the language model be reduced by removing N-grams from the language model. Generally, N-grams that have N-gram probabilities equal to zero are not represented in the language model. A language model can thus be reduced in size by pruning, which means that the probability for specific N-grams is set to zero if they are judged to be unimportant (i.e. they have low probability).
Quantization
   Document “Comparison of Width-wise and Length-wise Language Model Compression” by Whittaker, E.W.D. and Raj, B., in Proceedings 7^{th} European Conference on Speech Communication and Technology (Eurospeech), Aalborg, Denmark, Sep. 3-7, 2001 proposes a codebook, wherein the single N-gram probabilities are represented by indices into a codebook rather than representing the N-gram probabilities directly. The memory saving results provided by storing the codebook index requires less memory than storing the N-gram probability directly. For instance, if direct representation of one N-gram probability requires 32 bits (corresponding to the size of a float in C programming language), then the storage for the N-gram probability itself is reduced to a fourth if an 8-bit index into a 256-element codebook is used to represent the N-gram probabilities. Of course, also the codebook has to be stored, which reduces the memory savings.
Clustering
   U.S. Pat. No. 6,782,357 proposes that word classes be identified, and N-gram probabilities shared between the words in each class. An example class could be the weekdays (Monday to Friday). Such classes can be created manually, or they can be derived automatically.

### SUMMARY OF THE INVENTION

The present invention proposes an alternative approach for compressing N-gram language models.

According to a first aspect of the present invention, a method for compressing a language model that comprises a plurality of N-grams and associated N-gram probabilities is proposed. Said method comprises forming at least one group of N-grams from said plurality of N-grams; sorting N-gram probabilities associated with said N-grams of said at least one group of N-grams; and determining a compressed representation of said sorted N-gram probabilities.

Therein, an N-gram is understood as a sequence of N words, and the associated N-gram probability is understood as the conditional probability that the last word of the sequence of N words follows the (N−1) preceding words. Said language model is an N-gram language model, which models the probability of a sentence as a product of the probabilities of the individual words in the sentence by taking into account the (N−1)-tuples of preceding words with respect to each word of the sentence. Typical, but not limiting values for N are 1, 2 and 3, and the corresponding N-grams are denoted as unigrams, bigrams and trigrams, respectively.

Said language model may for instance be deployed in the context of speech recognition or handwriting recognition, or similar applications where input data has to be recognized to arrive at a textual representation. Said language model may for instance be obtained from training performed on a plurality of text corpora. Said N-grams comprised in said language model may only partially have N-gram probabilities that are explicitly represented in said language model, whereas the remaining N-gram probabilities may be determined by a recursive back-off rule. Furthermore, said language model may already have been subject to pruning and/or clustering. Said N-gram probabilities may be quantized or non-quantized probabilities, and they may for instance be handled in logarithmic form to simplify multiplication.

From said plurality of N-grams comprised in said language model, at least one group of N-grams is formed. This forming may for instance be performed according to a pre-defined criterion. For instance, in case of a unigram language model (N=1), said at least one group of N-grams may comprise all N-grams of said plurality of N-grams comprised in said language model. For a bigram (N=2) (or trigram) language model, those N-grams from said plurality of N-grams that share the same history (i.e. those N-grams that are conditioned on the same (N−1) preceding words) may for instance form respective groups of N-grams.

The N-gram probabilities associated with the N-grams in said at least one group are sorted. This sorting is performed with respect to the magnitude of the N-gram probabilities and may either target an increasing or decreasing arrangement of said N-gram probabilities. Said sorting yields a set of sorted N-gram probabilities, in which the original sequence of N-gram probabilities is generally changed. Said N-grams associated with the sorted N-gram probabilities may be accordingly re-arranged as well. Alternatively, a mutual allocation between the N-grams and their associated N-gram probabilities may for instance be stored, so that the association between N-grams and N-gram probabilities is not lost by sorting of the N-gram probabilities.

For said sorted N-gram probabilities, a compressed representation is determined. Therein, the fact that the N-gram probabilities are sorted is exploited to increase efficiency of compression. For instance, said compressed representation may be a sampled representation of said sorted N-gram probabilities, wherein the order of the N-gram probabilities allows to not include all N-gram probabilities in said compressed representation and to reconstruct (e.g. to interpolate) the non-included N-gram probabilities from neighboring N-gram probabilities that are included in said compressed representation. As a further example of exploitation of the fact that the sorted N-gram probabilities are sorted, said compressed representation of said sorted N-gram probabilities may be an index into a codebook, which comprises a plurality of indexed sets of probability values. The fact that said N-gram probabilities of a group of N-grams are sorted increases the probability that the sorted N-gram probabilities can be represented by a pre-defined set of sorted probability values comprised in said codebook, or may increase the probability that two different groups of N-grams at least partially resemble each other and thus can be represented (in full or in part) by the same indexed set of probability values in said codebook. In both exemplary cases, the codebook may comprise less indexed sets of probability values than there exist groups of N-grams.

According to an embodiment of the method of the present invention, said at least one group of N-grams is formed from N-grams of said plurality of N-grams that are conditioned on the same (N−1)-tuple of preceding words. Thus N-grams that have the same history are combined into a group, respectively. This may allow to store the history of the N-grams of each group of N-grams only once for all N-grams of said group, instead of having to explicitly store the history for each N-gram in the group, which may be the case if the histories within a group of N-grams would not be equal. As an example, in case of a bigram model (N=2), those bigrams that are conditioned on the same preceding word are put into one group. If this group comprises 20 bigrams, only the single preceding word and the 20 words following this single word according to each bigram have to be stored, and not the 40 words comprised in all the 20 bigrams.

According to a further embodiment of the method of the present invention, said compressed representation of said sorted N-gram probabilities is a sampled representation of said sorted N-gram probabilities. The fact that said sorted N-gram probabilities are in an increasing or decreasing order allows to sample the sorted N-gram probabilities to obtain said compressed representation of said N-gram probabilities, wherein at least one of said N-gram probabilities may then not be contained in said compressed representation of said sorted N-gram probabilities. During decompression, then N-gram probabilities that are not contained in said compressed representation of N-gram probabilities can be interpolated from one, two or more neighboring N-gram probabilities that are contained in said compressed representation. A simple approach may be to perform linear sampling, for instance to include every n-th N-gram probability of said sorted N-gram probabilities into said compressed representation, with n denoting an integer value larger than one.

According to this embodiment of the method of the present invention, said sampled representation of said sorted N-gram probabilities may be a logarithmically sampled representation of said sorted N-gram probabilities. It may be characteristic of the sorted N-gram probabilities that the rate of change is larger for the first N-gram probabilities than for the last N-gram probabilities, so that, instead of linear sampling, logarithmic sampling may be more advantageous, wherein logarithmic sampling is understood in a way that the indices of the N-gram probabilities from the set of sorted N-gram probabilities that are to be included into the compressed representation are at least partially related to a logarithmic function. For instance, then not every n-th N-gram probability is included into the compressed representation, but the N-gram probabilities with indices 0,1,2,3,5,8,12,17,23, etc.

According to a further embodiment of the method of the present invention, said compressed representation of said sorted N-gram probabilities comprises an index into a codebook that comprises a plurality of indexed sets of probability values. Therein, the term “indexed” is to be understood in a way that each set of probability values is uniquely associated with an index. Said codebook may for instance be a pre-defined codebook comprising a plurality of pre-defined indexed sets of probability values. Said indexed sets of probability values are sorted with increasing or decreasing magnitude, wherein said magnitude ranges between 0 and 1.0, or −∞ and 0 (in logarithmic scale). Therein, the length of said indexed sets of probability values may be the same for all indexed sets of probability values comprised in said pre-defined codebook, or may be different. The indexed sets of probability values comprised in said pre-defined codebook may then for instance be chosen in a way that the probability that one of said indexed sets of probability values (or a portion thereof) closely resembles a set of sorted N-gram probabilities that is to be compressed is high. During said generating of said compressed representation of said sorted N-gram probabilities, then the indexed set of probability values (or a part thereof) that is most similar to said sorted N-gram probabilities is determined, and the index of this determined indexed set of probability values is then used as at least a part of said compressed representation. If the number of values of said indexed set of probability values is larger than the number of N-gram probabilities in said set of sorted N-gram probabilities that is to be represented in compressed form, said compressed representation may, in addition to said index, further comprise an indicator for the number of N-gram probabilities in said sorted set of N-gram probabilities. Alternatively, this number may also be automatically derived and then may not be contained in said compressed representation. Equally well, said compressed representation may, in addition to said index, further contain an offset (or shifting) parameter, if said sorted set of N-gram probabilities is found to resemble a sub-sequence of values contained in one of said indexed sets of probability values comprised in said pre-defined codebook.

As an alternative to said pre-defined codebook, a codebook that is set up step by step during the compression of the language model may be imagined. For instance, as a first indexed set of probability values, the first set of sorted N-gram probabilities that is to be represented in compressed form may be used. When then a compressed representation for a second set of sorted N-gram probabilities is searched, it may be decided if said first indexed set of probability values can be used, for instance when the difference between the N-gram probabilities of said second set and the values in said first indexed set of probability values are below a certain threshold, or if said second set of sorted N-gram probabilities shall form the second indexed set of probability values in said codebook. For the third set of N-gram probabilities to be represented in compressed form, then comparison may take place for the first and second indexed sets of probability values already contained in the codebook, and so on. Similar to the case of the pre-defined codebook, both equal and different lengths of the indexed sets of probability values comprised in said codebook may be possible, and in addition to the index in the compressed representation, also an offset/shifting parameter may be introduced.

Before determining which indexed set of probability values (or part thereof) most closely resembles the sorted N-gram probabilities that are to be represented in compressed form, said sorted N-gram probabilities may be quantized.

According to a further embodiment of the method of the present invention, a number of said indexed sets of probability values comprised in said codebook is smaller than a number of said groups formed from said plurality of N-grams. The larger the ratio between the number of groups formed from said plurality of N-grams and the number of indexed sets of probability values comprised in said codebook, the larger the compression according to the first aspect of the present invention.

According to a further embodiment of the method of the present invention, said language model comprises N-grams of at least two different levels N₁ and N₂, and wherein at least two compressed representations of sorted N-gram probabilities respectively associated with N-grams of different levels comprise indices to said codebook. For instance, in a bigram language model, both bigrams and unigrams may have to be stored, because the unigrams may be required for the calculation of bigram probabilities that are not explicitly stored in the language model. This calculation may for instance be performed based on a recursive backoff algorithm. In this example of a bigram language model, the unigrams then represent the N-grams of level N₁, and the bigrams represent the N-grams of level N₂. For both N-grams, respective groups may be formed, and the sorted N-gram probabilities of said groups may then be represented in compressed form by indices to one and the same codebook.

According to a second aspect of the present invention, a software application product is proposed, comprising a storage medium having a software application for compressing a language model that comprises a plurality of N-grams and associated N-gram probabilities embodied therein. Said software application comprises program code for forming at least one group of N-grams from said plurality of N-grams; program code for sorting N-gram probabilities associated with said N-grams of said at least one group of N-grams; and program code for determining a compressed representation of said sorted N-gram probabilities.

Said storage medium may be any volatile or non-volatile memory or storage element, such as for instance a Read-Only Memory (ROM), Random Access Memory (RAM), a memory stick or card, and an optically, electrically or magnetically readable disc. Said program code comprised in said software application may be implemented in a high level procedural or object oriented programming language to communicate with a computer system, or in assembly or machine language to communicate with a digital processor. In any case, said program code may be a compiled or interpreted code. Said storage medium may for instance be integrated or connected to a device that processes data at least partially based on said language model. Said device may for instance be a portable communication device or a part thereof.

For this software application product according to the second aspect of the present invention, the same characteristics and advantages as already discussed in the context of the method according to the first aspect of the present invention apply.

According to an embodiment of the software application product of the present invention, said at least one group of N-grams is formed from N-grams of said plurality of N-grams that are conditioned on the same (N−1)-tuple of preceding words.

According to a third aspect of the present invention, a storage medium for at least partially storing a language model that comprises a plurality of N-grams and associated N-gram probabilities is proposed. Said storage medium comprises a storage location containing a compressed representation of sorted N-gram probabilities associated with N-grams of at least one group of N-grams formed from said plurality of N-grams.

Said storage medium may be any volatile or non-volatile memory or storage element, such as for instance a Read-Only Memory (ROM), Random Access Memory (RAM), a memory stick or card, and an optically, electrically or magnetically readable disc. Said storage medium may for instance be integrated or connected to a device that processes data at least partially based on said language model. Said device may for instance be a portable communication device or a part thereof.

For this storage medium according to the third aspect of the present invention, the same characteristics and advantages as already discussed in the context of the method according to the first aspect of the present invention apply. In addition to said storage location containing a compressed representation of sorted N-gram probabilities, said storage medium may comprise a further storage location containing the N-grams associated with said sorted N-gram probabilities. If said compressed representation of said sorted N-gram probabilities comprises an index into a codebook, said codebook may, but does not necessarily need to be contained in a further storage location of said storage medium. Said storage medium may be provided with the data for storage into its storage locations by a device that houses said storage medium, or by an external device.

According to an embodiment of the storage medium of the present invention, said at least one group of N-grams is formed from N-grams of said plurality of N-grams that are conditioned on the same (N−1)-tuple of preceding words.

According to a fourth aspect of the present invention, a device for compressing a language model that comprises a plurality of N-grams and associated N-gram probabilities is proposed. Said device comprises means for forming at least one group of N-grams from said plurality of N-grams; means for sorting N-gram probabilities associated with said N-grams of said at least one group of N-grams; and means for determining a compressed representation of said sorted N-gram probabilities.

For this device according to the fourth aspect of the present invention, the same characteristics and advantages as already discussed in the context of the method according to the first aspect of the present invention apply. Said device according to the fourth aspect of the present invention may for instance be integrated in a device that processes data at least partially based on said language model. Alternatively, said device according to the fourth aspect of the present invention may also be continuously or only temporarily connected to a device that processes data at least partially based on said language model, wherein said connection may be of wired or wireless type. For instance, said device that processes said data may be a portable device, and a language model that is to be stored into said portable device then can be compressed by said device according to the fourth aspect of the present invention, for instance during manufacturing of said portable device, or during an update of said portable device.

According to an embodiment of the fourth aspect of the present invention, said at least one group of N-grams is formed from N-grams of said plurality of N-grams that are conditioned on the same (N−1)-tuple of preceding words.

According to an embodiment of the fourth aspect of the present invention, said means for determining a compressed representation of said sorted N-gram probabilities comprise means for sampling said sorted N-gram probabilities.

According to an embodiment of the fourth aspect of the present invention, said compressed representation of said sorted N-gram probabilities comprises an index into a codebook that comprises a plurality of indexed sets of probability values, and said means for determining a compressed representation of said sorted N-gram probabilities comprises means for selecting said index.

According to a fifth aspect of the present invention, a device for processing data at least partially based on a language model that comprises a plurality of N-grams and associated N-gram probabilities is proposed. Said device comprises a storage medium having a compressed representation of sorted N-gram probabilities associated with N-grams of at least one group of N-grams formed from said plurality of N-grams stored therein.

For this device according to the fifth aspect of the present invention, the same characteristics and advantages as already discussed in the context of the method according to the first aspect of the present invention apply.

Said storage medium comprised in said device may be any volatile or non-volatile memory or storage element, such as for instance a Read-only Memory (ROM), Random Access Memory (RAM), a memory stick or card, and an optically, electrically or magnetically readable disc. Said storage medium may store N-gram probabilities associated with all N-grams of said language model in compressed form. Said device is also capable of retrieving said N-gram probabilities from said compressed representation. If said device furthermore stores or has access to all N-grams associated with said N-gram probabilities, all components of said language model are available, so that the language model can be applied to process data.

Said device may for instance be a device that performs speech recognition or handwriting recognition. Said device may be capable of generating and/or manipulating said language model by itself. Alternatively, all or some components of said language model may be input or manipulated by an external device.

According to an embodiment of the fifth aspect of the present invention, said at least one group of N-grams is formed from N-grams of said plurality of N-grams that are conditioned on the same (N−1)-tuple of preceding words.

According to an embodiment of the fifth aspect of the present invention, said compressed representation of said sorted N-gram probabilities is a sampled representation of said sorted N-gram probabilities.

According to an embodiment of the fifth aspect of the present invention, said compressed representation of said sorted N-gram probabilities comprises an index into a codebook that comprises a plurality of indexed sets of probability values.

According to an embodiment of the fifth aspect of the present invention, said device is portable communication device. Said device may for instance be a mobile phone.

These and other aspects of the invention will be apparent from and elucidated with reference to the embodiments described hereinafter.

### BRIEF DESCRIPTION OF THE FIGURES

In the figures show:

FIG. 1a: a schematic block diagram of an embodiment of a device for compressing a language model and processing data at least partially based on said language model according to the present invention;

FIG. 1b: a schematic block diagram of an embodiment of a device for compressing a language model and of a device for processing data at least partially based on a language model according to the present invention;

FIG. 2: a flowchart of an embodiment of a method for compressing a language model according to the present invention;

FIG. 3a: a flowchart of a first embodiment of a method for determining a compressed representation of sorted N-gram probabilities according to the present invention;

FIG. 3b: a flowchart of a second embodiment of a method for determining a compressed representation of sorted N-gram probabilities according to the present invention;

FIG. 3c: a flowchart of a third embodiment of a method for determining a compressed representation of sorted N-gram probabilities according to the present invention;

FIG. 4a: a schematic representation of the contents of a first embodiment of a storage medium for at least partially storing a language model according to the present invention;

FIG. 4b: a schematic representation of the contents of a second embodiment of a storage medium for at least partially storing a language model according to the present invention; and

FIG. 4c: a schematic representation of the contents of a third embodiment of a storage medium for at least partially storing a language model according to the present invention.

### DETAILED DESCRIPTION OF THE INVENTION

In this detailed description, the present invention will be described by means of exemplary embodiments. Therein, it is to be noted that the description in the opening part of this patent specification can be considered to supplement this detailed description.

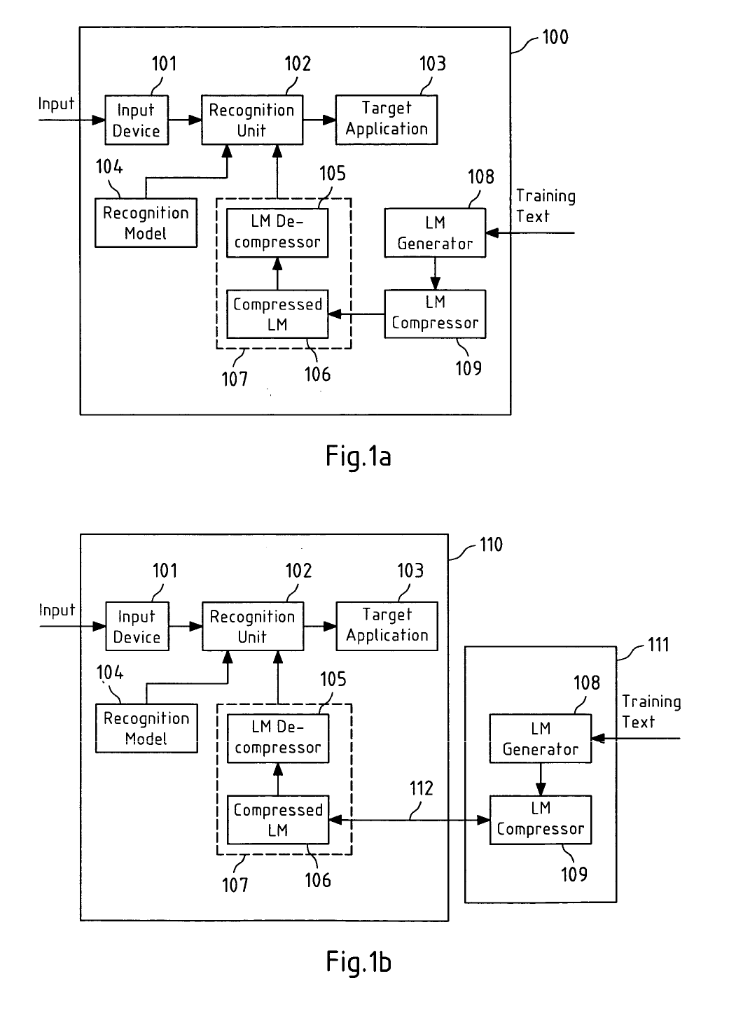

In FIG. 1a, a block diagram of an embodiment of a device 100 for compressing a Language Model (LM) and processing data at least partially based on said LM according to the present invention is schematically depicted. Said device 100 may for instance be used for speech recognition or handwriting recognition. Device 100 may for instance be incorporated into a portable multimedia device, as for instance a mobile phone or a personal digital assistant. Equally well, device 100 may be incorporated into a desktop or laptop computer or into a car, to name but a few possibilities. Device 100 comprises an input device 101 for receiving input data, as for instance spoken utterances or handwritten sketches. Correspondingly, input device 101 may comprise a microphone or a screen or scanner, and also means for converting such input data into an electronic representation that can be further processed by recognition unit 102.

Recognition unit 102 is capable of recognizing text from the data received from input device 101. Recognition is based on a recognition model, which is stored in unit 104 of device 100, and on an LM 107 (represented by storage unit 106 and LM decompressor 105). For instance, in the context of speech recognition, said recognition model stored in unit 104 may be an acoustic model. Said LM describes the possible sentences that can be recognized, and is embodied as an N-gram LM. This N-gram LM models the probability of a sentence as a product of the probability of the individual words in the sentence by taking into account only the (N−1)-tuple of preceding words. To this end, the LM comprises a plurality of N-grams and the associated N-gram probabilities.

In device 100, LM 107 is stored in compressed form in a storage unit 106, which may for instance be a RAM or ROM of device 100. This storage unit 106 may also be used for storage by other components of device 100. In order to make the information contained in the compressed LM available to recognition unit 102, device 100 further comprises an LM decompressor 105. This LM decompressor 105 is capable of retrieving the compressed information contained in storage unit 106, for instance N-gram probabilities that have been stored in compressed form.

The text recognized by recognition unit 102 is forwarded to a target application 103. This may for instance be a text processing application, that allows a user of device 100 to edit and/or correct and/or store the recognized text. Device 100 then may be used for dictation, for instance of emails or short messages in the context of the Short Message Service (SMS) or Multimedia Message Service (MMS). Equally well, said target application 103 may be capable of performing specific tasks based on the recognized text received, as for instance an automatic dialing application in a mobile phone that receives a name that has been spoken by a user and recognized by recognition unit 102 and then automatically triggers a call to a person with this name. Similarly, a menu of device 100 may be browsed or controlled by the commands recognized by recognition unit 102.

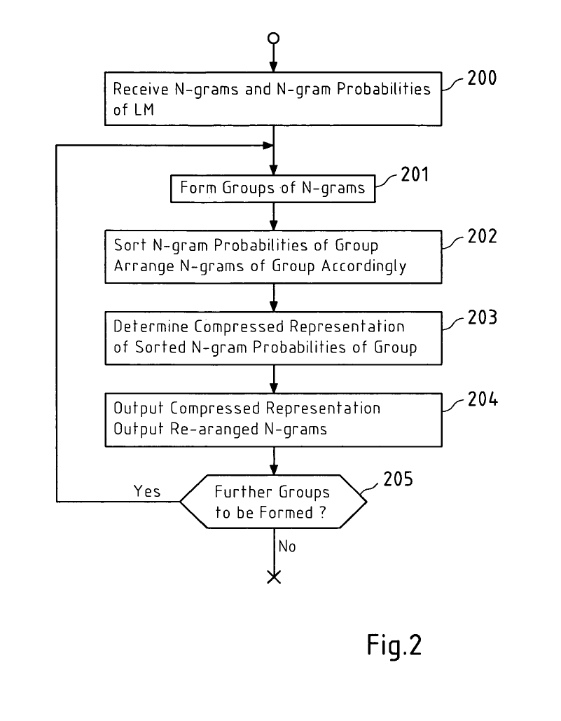

In addition to its functionality to process input data at least partially based on LM 107, device 100 is furthermore capable of compressing LM 107. To this end, device 100 comprises an LM generator 108. This LM generator 108 receives training text and determines, based on the training text, the N-grams and associated N-gram probabilities of the LM, as it is well known in the art. In particular, a backoff algorithm may be applied to determine N-gram probabilities that are not explicitly represented in the LM. LM generator 108 then forwards the LM, i.e. the N-grams and associated N-gram probabilities, to LM compressor 109, which performs the steps of the method for compressing a language model according to the present invention to reduce the storage amount required for storing the LM. This is basically achieved by sorting the N-gram probabilities and storing the sorted N-gram probabilities under exploitation of the fact that they are sorted, e.g. by sampling or by using indices into a codebook. The functionality of LM 109 may be represented by a software application that is stored in a software application product. This software application then may be processed by a digital processor upon reception of the LM from the LM generator 108. More details on the process of LM compression according to the present invention will be discussed with reference to FIG. 2 below.

The compressed LM as output by LM processor 109 is then stored into storage unit 106, and then is, via LM decompressor 105, available as LM 107 to recognition unit 102.

FIG. 1b schematically depicts a block diagram of an embodiment of a device 111 for compressing a language model and of a device 110 for processing data at least partially based on a language model according to the present invention. In contrast to FIG. 1a, thus the functionality to process data at least partially based on a language model and the functionality to compress said language model has been distributed across two different devices. Therein, in the devices 110 and 111 of FIG. 1b, components with the same functionality as their counterparts in FIG. 1a have been furnished with the same reference numerals.

Device 111 comprises an LM generator 108 that constructs, based on training text, an LM, and the LM compressor 109, which compresses this LM according to the method of the present invention. The compressed LM is then transferred to storage unit 106 of device 110. This may for instance be accomplished via a wired or wireless connection 112 between device 110 and 111. Said transfer may for instance be performed during the manufacturing process of device 110, or later, for instance during configuration of device 110. Equally well, said transfer of the compressed LM from device 111 to device 110 may be performed to update the compressed LM contained in storage unit 106 of device 110.

FIG. 2 is a flowchart of an embodiment of a method for compressing a language model according to the present invention. This method may for instance be performed by LM compressor 109 of device 100 in FIG. 1a or device 111 of FIG. 1b. As already stated above, the steps of this method may be implemented in a software application that is stored on a software application product.

In a first step 200, a LM in terms of N-grams and associated N-gram probabilities is received, for instance from LM generator 108 (see FIGS. 1a and 1b). In the following steps, sequentially groups of N-grams are formed, compressed and output.

In step 201, a first group of N-grams from the plurality of N-grams comprised in the LM is formed. In case of a unigram LM, i.e. for N=1, this group may comprise all N-grams of the unigram LM. In case of LMs with N>1, as for instance bigram and trigram LMs, all N-grams that share the same history h, i.e. that have the same (N−1) preceding words in common, may form a group. For instance, in case of a bigram LM, then all bigrams (wᵢ₋₁,wᵢ) starting with the same word wᵢ₋₁ form a group of bigrams. Forming groups in this manner is particularly advantageous because the history h of all N-grams of a group then only has to be stored once, instead of having to store, for each N-gram, both the history h and the last word w.

In step 202, the set of N-gram probabilities that are respectively associated with the N-grams of the present group are sorted, for instance in descending order. The corresponding N-grams are re-arranged accordingly, so that the i-th N-gram probability of the sorted N-gram probabilities corresponds to the i-th N-gram in the group of N-grams, respectively. As an alternative to re-arranging the N-grams, equally well the sequence of the N-grams may be maintained as it is (for instance an alphabetic sequence), and then a mapping indicating the association between N-grams and their respective N-gram probabilities in the sorted set of N-gram probabilities may be set up.

As an example for the outcome of steps 201 and 202, the following is a group of bigrams (N=2) that share the same history (the word “YOUR”). The bigram probabilities of this group of bigrams (which bigram probabilities can be denoted as a “profile”) have been sorted in descending order, and the corresponding bigrams have been re-arranged accordingly:

| | |
|---|---|
| YOUR MESSAGE | −0.857508 |
| YOUR OFFICE | −1.263640 |
| YOUR ACCOUNT | −1.372151 |
| YOUR HOME | −1.372151 |
| YOUR JOB | −1.372151 |
| YOUR NOSE | −1.372151 |
| YOUR OLD | −1.372151 |
| YOUR LOCAL | −1.517140 |
| YOUR HEAD | −1.736344 |
| YOUR AFTERNOON | −2.200477 |

Therein, the bigram probabilities are given in logarithmic representation, i.e. P(MESSAGE|YOUR)=10⁻⁸⁵⁷⁵⁰⁸=0.139, which may be advantageous since multiplication of bigram probabilities is simplified.

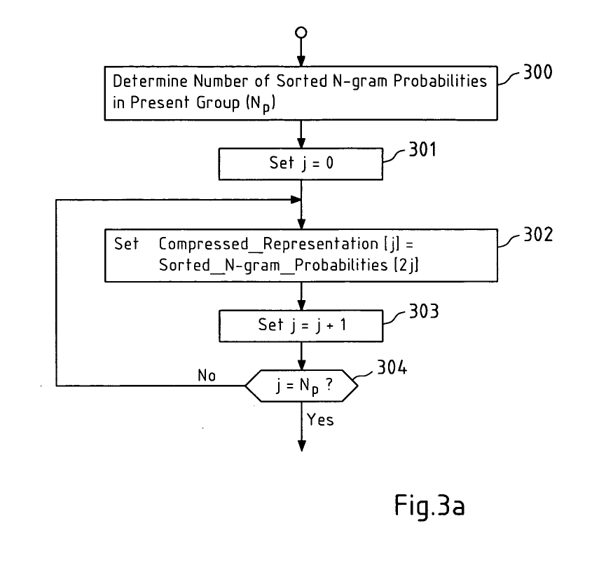

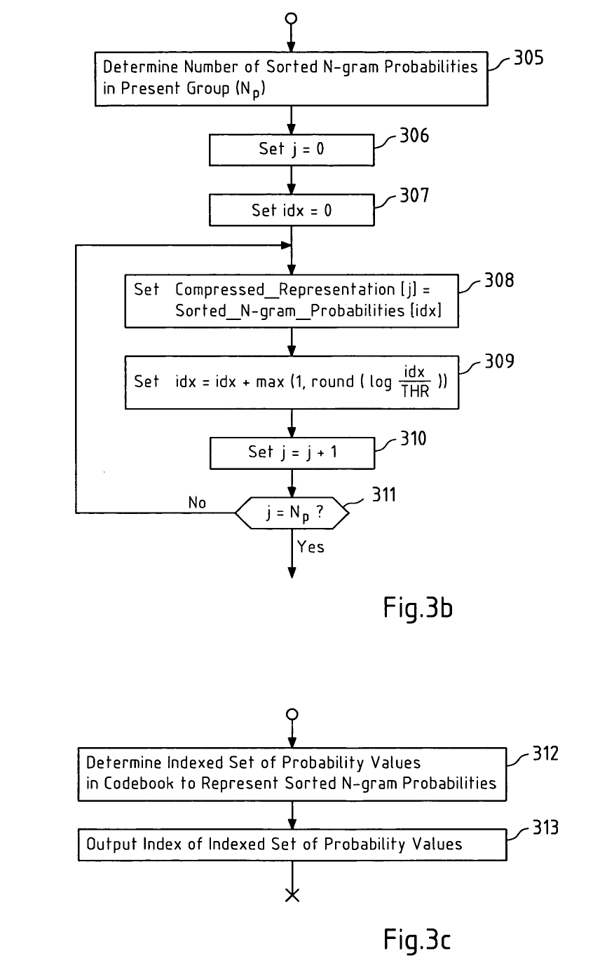

In a step 203, a compressed representation of the sorted N-gram probabilities of the present group is determined, as will be explained in more detail with respect to FIGS. 3a, 3b and 3c below. Therein, the fact that the N-gram probabilities are sorted is exploited.

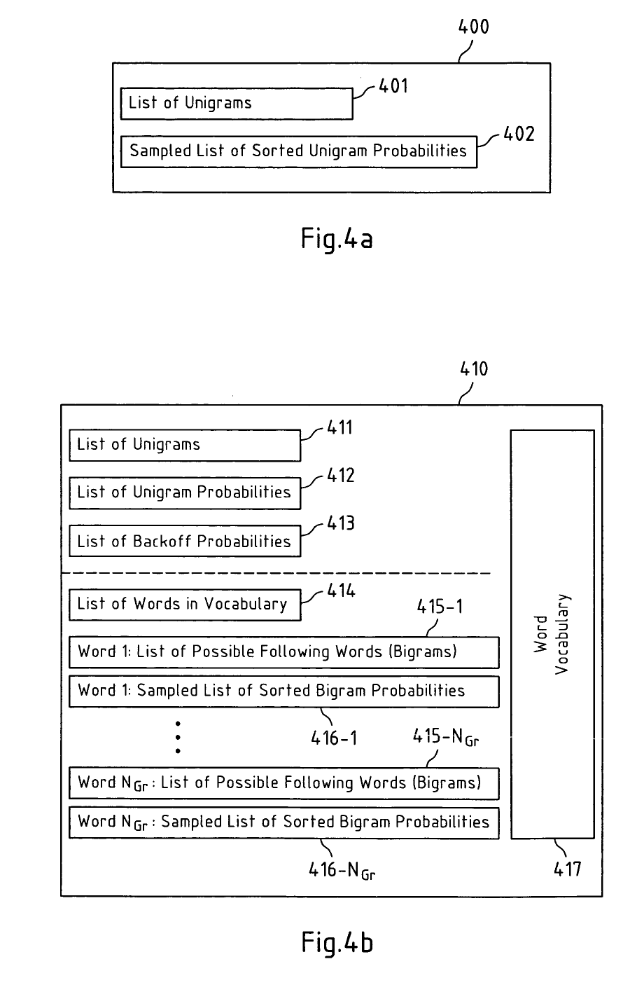

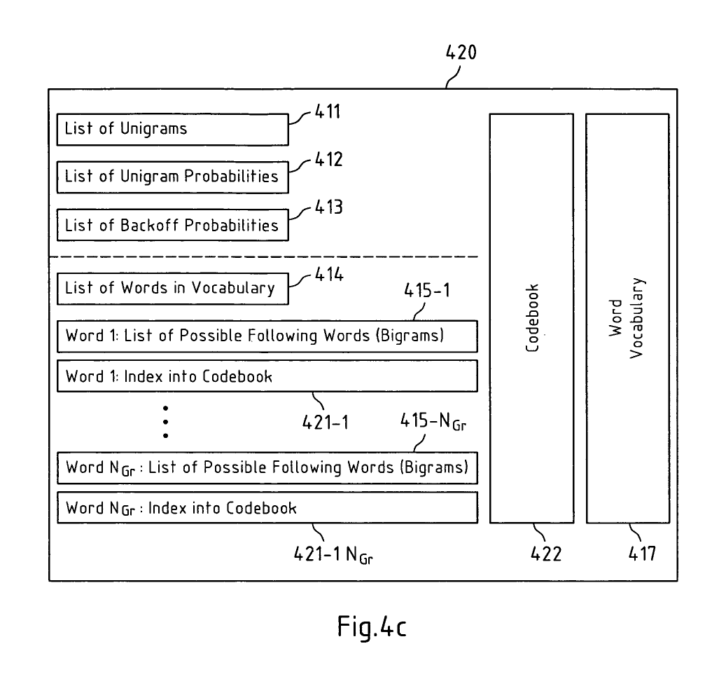

In a step 204, the compressed representation of the sorted N-gram probabilities is output, together with the corresponding re-arranged N-grams. This output may for instance be directed to storage unit 106 of device 100 in FIG. 1a or device 110 of FIG. 1b. Examples of the format of this output will be given below in the context of FIGS. 4a, 4b and 4c.

In a step 205, it is then checked if further groups of N-grams have to be formed. If this is the case, the method jumps back to step 201. Otherwise, the method terminates. The number of groups to be formed may for instance be a pre-determined number, but it may equally well be dynamically determined.

FIG. 3a is a flowchart of a first embodiment of a method for determining a compressed representation of sorted N-gram probabilities according to the present invention, as it may for instance be performed in step 203 of the flowchart of FIG. 2. In this first embodiment, linear sampling is applied to determine the compressed representation. Linear sampling allows to skip sorted N-gram probabilities in the compressed representation, since these sorted N-gram probabilities can be recovered from neighboring N-gram probabilities that were included into the compressed representation. It is important to note that sampling can only be applied if the N-gram probabilities to be compressed are sorted in ascending or descending order.

In a first step 300, the number Nₚ of sorted N-gram probabilities of the present group of N-grams is determined. Then, in step 301, a counter variable j is initialized to zero. The actual sampling then takes place in step 302. Therein, the array “Compressed_Representation” is understood as an empty array with Nₚ/2 elements that, after completion of the method according to the flowchart of FIG. 3a, shall contain the compressed representation of the sorted N-gram probabilities of the present group. The Nₚ-element array “Sorted_N-gram_Probabilities” is understood to contain the sorted N-gram probabilities of the present group of N-grams, as it is determined in step 202 of the flowchart of FIG. 2. In step 302, thus the j-th array element in array “Compressed_Representation” is assigned the value of the (2*j)-th array element in array “Sorted_N-gram_Probabilities”. Subsequently, in step 303, the counter variable j is increased by one, and in a step 304, it is checked if the counter variable j is already equal to Nₚ, in which case the method terminates. Otherwise, the method jumps back to step 302.

The process performed by steps 302 to 304 can be explained as follows: For j=0, the first element (j=0) in array “Compressed_Representation” is assigned the first element (2*j=0) in array “Sorted_N-gram_Probabilities”, for j=1, the second element (j=1) in array “Compressed_Representation” is assigned the third element (2*j=2) in array “Sorted-N-gram_Probabilities”, for j=2, the third element (j=2) in array “Compressed-Representation” is assigned the fifth element (2*j=4) in array “Sorted-N-gram_Probabilities”, and so forth.

In this way, thus only every second N-gram probability of the sorted N-gram probabilities is stored in the compressed representation of the sorted N-gram probabilities and thus, essentially, the storage space required for the N-gram probabilities is halved. It is readily clear that, instead of sampling every second value (as illustrated in FIG. 3a), equally well every l-th value of the sorted N-gram probabilities may be sampled, with l denoting an integer number.

The recovery of the N-gram probabilities that were not included into the compressed representation of the sorted N-gram probabilities can then be performed by linear interpolation. For instance, to interpolate n unknown samples s₁, . . . ,sₙ between two given samples pᵢ and pᵢ₊₁, the following formula can be applied:
sₖ=pᵢ+k(pᵢ₊₁−Pᵢ)/n.

This interpolation may for instance be performed by LM decompressor 105 in device 100 of FIG. 1a and device 110 in FIG. 1b in order to retrieve N-gram probabilities from the compressed LM that are not contained in the compressed representation of the sorted N-gram probabilities.

FIG. 3b is a flowchart of a second embodiment of a method for determining a compressed representation of sorted N-gram probabilities according to the present invention, as it may for instance be performed in step 203 of the flowchart of FIG. 2. Therein, in contrast to the first embodiment of this method depicted in the flowchart of FIG. 3a, logarithmic sampling, and not linear sampling, is used. Logarithmic sampling accounts for the fact that the rate of change in the N-gram probabilities of the sorted set of N-gram probabilities of a group of N-grams is larger for the first sorted N-gram probabilities than for the last sorted N-gram probabilities.

In the flowchart of FIG. 3b, steps 305, 306, 310 and 311 correspond to steps 300, 301, 303 and 304 of the flowchart of FIG. 3a, respectively. The decisive difference is to be found in steps 307, 308 and 309. In step 307, a variable idx is initialized to zero. In step 308, the array “Compressed_Representation” is assigned N-gram probabilities taken from the idx-th position in the array “Sorted_N-gram_Probabilities”, and in step 309, the variable idx is logarithmically incremented. Therein, in step 309, the function max(x₁, x₂) returns the larger value of two values x₁ and x₂; the function round (x) rounds a value x to the next closest integer value, the function log(y) computes the logarithm to the base of 10 of y, and THR is a pre-defined threshold.

Performing the method steps of the flowchart of FIG. 3b for THR=0.5 causes the variable idx to take the following values: 0,1,2,3,5,8,12,17,23,29,36, . . . . Since only the sorted N-gram probabilities of at position idx in the array “Sorted_N-gram_Probabilities” are sequentially copied into the array “Compressed_Representation” in step 308, it can readily be seen that the distance between the sampled N-gram probabilities increases logarithmically, thus reflecting the fact that the N-gram probabilities at the beginning of the sorted set of N-gram probabilities have a larger rate of change than the N-gram probabilities at the end of the sorted set of N-gram probabilities.

The recovery of the N-gram probabilities that were not included into the compressed representation of the sorted N-gram probabilities due to logarithmic sampling can once again be performed by appropriate interpolation. This interpolation may for instance be performed by LM decompressor 105 in device 100 of FIG. 1a and device 110 in FIG. 1b in order to retrieve N-gram probabilities from the compressed LM that are not contained in the compressed representation of the sorted N-gram probabilities.

FIG. 3c is a flowchart of a third embodiment of a method for determining a compressed representation of sorted N-gram probabilities, as it may for instance be performed in step 203 of the flowchart of FIG. 2. In this third embodiment, instead of sampling the sorted N-gram probabilities associated with a group of N-grams, the sorted nature of these N-gram probabilities is exploited by using a codebook and representing the sorted N-gram probabilities by an index into said codebook. Therein, said codebook comprises a plurality of indexed sets of probability values, which are either pre-defined or dynamically added to said codebook during said compression of the LM.

In the flowchart of FIG. 3c, in a first step 312, an indexed set of probability values is determined in said codebook so that this indexed set of probability values represents the sorted N-gram probabilities of the presently processed group of N-grams in a satisfactory manner. In a step 313, then the index of this indexed set of probability values is output as compressed representation. In contrast to the previous embodiments (see FIGS. 3a and 3b), thus the compressed representation of the sorted N-gram probabilities is not a sampled set of N-gram probabilities, but an index into a codebook. With respect to step 312, at least two different types of codebooks may be differentiated. A first type of codebook may be a pre-defined codebook. Such a codebook may be determined prior to compression, for instance based on statistics of training texts. A simple example of such a pre-defined codebook is depicted in the following Tab. 1 (Therein, it is exemplarily assumed that each group of N-grams has the same number of N-grams, that the number of N-grams in each group is four, and that the pre-defined codebook only comprises five indexed sets of probability values. Furthermore, for simplicity of presentation, the probabilities are given in linear representation, whereas in practice, storage in logarithmic representation may be more convenient to simplify multiplication of probabilities.):

TABLE 1
Example of a Pre-defined Codebook

| | | | |
|---|---|---|---|
| 0.7 | 0.1 | 0.1 | 0.1 |
| 0.6 | 0.2 | 0.1 | 0.1 |
| 0.5 | 0.2 | 0.2 | 0.1 |
| 0.4 | 0.3 | 0.2 | 0.1 |
| 0.3 | 0.3 | 0.3 | 0.1 |

Each row of this pre-defined codebook may be understood as a set of probability values. Furthermore, the first row of this pre-defined codebook may be understood to be indexed with the index 1, the second row with the index 2, and so forth.

According to step 312 of the flowchart of FIG. 3c, when assuming that the sorted N-gram probabilities of the currently processed group of N-grams are 0.53, 0.22, 0.20, 0.09, it is readily clear that the third row of the pre-defined codebook (see Tab. 1 above) is suited to represent the sorted N-gram probabilities. Consequently, in step 313, the index 3 (which indexes the third row) will be output by the method.

A second type of codebook may be a codebook that is dynamically filled with indexed sets of probability values during the compression of the LM. Each time step 312 (corresponding to step 203 of the flowchart of FIG. 2) is performed, then either a new indexed set of probability values may be added to the codebook, or an already existing indexed set of probability values may be chosen to represent the sorted N-gram probabilities of the currently processed group of N-grams. Therein, only a new indexed set of probability values may be added to the codebook if a difference between the sorted N-gram probabilities of the group of N-grams that is currently processed and the indexed sets of probability values already contained in the codebook exceeds a pre-defined threshold. Furthermore, when adding a new indexed set of probability values to the codebook, not exactly the sorted N-gram probabilities of the currently processed groups of N-grams, but a rounded/quantized representation thereof may be added.

In the above examples, it was exemplarily assumed that the number of N-grams in each group of N-grams is equal. This may not necessarily be the case. However, it is readily understood that, for unequal numbers of N-grams in each group, it is either possible to work with codebooks that comprise indexed sets of probability values with different numbers of elements, or to work with codebooks that comprise indexed sets of probability values with the same numbers of elements, but then to use only a certain portion of the sets of probability values contained in the codebook, for instance only the first values comprised in each of said indexed sets of probability values. The number of N-gram probabilities in each group of N-gram probabilities can be either derived from the group of N-grams itself, or be stored, together with the index, in the compressed representation of the sorted set of N-gram probabilities. Furthermore, also an offset/shifting parameter may be included into this compressed representation, if the sorted N-gram probabilities are best represented by a portion in an indexed set of probability values that is shifted with respect to the first value of the indexed set.

The recovery of the sorted N-gram probabilities from the codebook is straightforward: For each group of N-grams, the index into the codebook (and, if required, also the number of N-grams in the present group and/or an offset/shifting parameter) is determined and, based on this information, the sorted N-gram probabilities are read from the codebook. This recovery may for instance be performed by LM decompressor 105 in device 100 of FIG. 1a and device 110 in FIG. 1b.

FIG. 4a is a schematic representation of the contents of a first embodiment of a storage medium 400 for at least partially storing an LM according to the present invention, as for instance storage unit 106 in the device 100 of FIG. 1a or in the device 110 of FIG. 1b.

Therein, for this exemplary embodiment, it is assumed that the LM is a unigram LM (N=1). Said LM can then be stored in storage medium 400 in compressed form by storing a list 401 of all the unigrams of the LM, and by storing a sampled list 402 of the sorted unigram probabilities associated with the unigrams of said LM. Said sampling of said sorted list 402 of unigrams may for instance be performed as explained with reference to FIGS. 3a or 3b above. Said list 401 of unigrams may be re-arranged according to the order of the sorted unigram probabilities, or may be maintained in its original order (e.g. an alphabetic order); in the latter case, then however a mapping that preserves the original association between unigrams and their unigram probabilities may have to be set up and stored in said storage medium 400.

FIG. 4b is a schematic representation of the contents of a second embodiment of a storage medium 410 for at least partially storing an LM according to the present invention, as for instance storage unit 106 in the device 100 of FIG. 1a or in the device 110 of FIG. 1b.

Therein, it is exemplarily assumed that the LM is a bigram LM. This bigram LM comprises a unigram section and a bigram section. In the unigram section, a list 411 of unigrams, a corresponding list 412 of unigram probabilities and a corresponding list 413 of backoff probabilities are stored for calculation of the bigram probabilities that are not explicitly stored. Therein, the unigrams, e.g. all words of the vocabulary the bigram LM is based on, are stored as indices into a word vocabulary 417, which is also stored in the storage medium 410. As an example, index “1” of a unigram in unigram list 411 may be associated with the word “house” in the word vocabulary. It is to be noted that the list 412 of unigram probabilities and/or the list 413 of backoff probabilities could equally well be stored in compressed form, i.e. they could be sorted and subsequently sampled similar as in the previous embodiment (see FIG. 4a). However, such compression may only give little additional compression gain with respect to the overall compression gain that can be achieved by storing the bigram probabilities in compressed fashion.

In the bigram section, a list 414 of all words comprised in the vocabulary on which the LM is based may be stored. This may however only be required if this list 414 of words differs in arrangement and/or size from the list 411 of unigrams or from the set of words contained in the word vocabulary 417. If list 414 is present, the words of list 414 are, as the words in the list 411 of unigrams, stored as indices into word vocabulary 417 rather than storing them explicitly.

The remaining portion of the bigram section of storage medium 410 comprises, for each word m in list 414, a list 415-m of words that can follow said word, and a corresponding sampled list 416-m of sorted bigram probabilities, wherein the postfix m ranges from 1 to N_{Gr}, and wherein N_{Gr} denotes the number of words in list 414. It is readily understood that a single word m in list 414, together with the corresponding list 415-m of words than can follow this word m, define a group of bigrams of said bigram LM, wherein this group of bigrams is characterized in that all bigrams of this group share the same history h (or, in other words, are conditioned on the same (N−1)-tuple of preceding words with N=2), with said history being the word m. For all bigrams of a group, the history h is stored only once, as a single word m in the list 414. This leads to a rather efficient storage of the bigrams.

Furthermore, for each group of bigrams, the corresponding bigram probabilities have been sorted and subsequently sampled, for instance according to one of the sampling methods according to the flowcharts of FIGS. 3a and 3b above. This allows for a particularly efficient storage of the bigram probabilities of a group of bigrams.

Finally, FIG. 4c is a schematic representation of the contents of a third embodiment of a storage medium 420 for at least partially storing an LM according to the present invention, as for instance storage unit 106 in the device 100 of FIG. 1a or in the device 110 of FIG. 1b. As in the second embodiment of FIG. 4b, it is exemplarily assumed that the LM is a bigram LM.

This third embodiment of a storage medium 420 basically resembles the second embodiment of a storage medium 410 depicted in FIG. 4b, and corresponding contents of both embodiments are thus furnished with the same reference numerals.

However, in contrast to the second embodiment of a storage medium 410, in this third embodiment of a storage medium 420, sorted bigram probabilities are not stored as sampled representations (see reference numerals 416-m in FIG. 4b), but as an index into a codebook 422 (see reference numerals 421-m in FIG. 4c). This codebook 422 comprises a plurality of indexed sets of probability values, as for instance exemplarily presented in Tab. 1 above, and allows sorted lists of bigram probabilities to be represented by an index 421-m, with the postfix m once again ranging from 1 to N_{Gr}, and N_{Gr} denoting the number of words in list 414. Therein, said codebook may comprise indexed sets of probability values that either have the same or different numbers of elements (probability values) per set. As already stated above in the context of FIG. 3c, at least in the former case, it may be advantageous to further store an indicator for the number of bigrams in each group of bigrams and/or an offset/shifting parameter in addition to the index 421-m. These parameters then jointly form the compressed representation of the sorted bigram probabilities. Furthermore, said codebook 422 may originally be a pre-determined codebook, or may have been set up during the actual compression of the LM.

The bigrams of a group of bigrams, which group is characterized in that the bigrams of this group share the same history, then are represented by the respective word m in the list 414 of words and the corresponding list of possible following words 415-m, and the bigram probabilities of this group are represented by an index into codebook 422, which index points to an indexed set of probability values.

It is readily clear that also the list 412 of unigram probabilities and/or the list 413 of backoff probabilities in the unigram section of storage medium 420 may be entirely represented by an index into codebook 422. Then, N-grams of two different levels (N₁=1 for the unigrams and N₂=2 for the bigrams) use share the same codebook 422.

The invention has been described above by means of exemplary embodiments. It should be noted that there are alternative ways and variations which are obvious to a skilled person in the art and can be implemented without deviating from the scope and spirit of the appended claims. In particular, the present invention adds to the compression of LMs that can be achieved with other techniques, such as LM pruning, class modeling and score quantization, i.e. the present invention does not exclude the possibility of using these schemes at the same time. The effectiveness of LM compression according to the present invention may typically depend on the size of the LM and may particularly increase with increasing size of the LM.

What is claimed is:

1. A method for compressing a language model that comprises a plurality of N-grams and associated N-gram probabilities, said method comprising:
forming at least one group of N-grams from said plurality of N-grams;
sorting N-gram probabilities associated with said N-grams of said at least one group of N-grams; and
determining a compressed representation of said sorted N-gram probabilities.

2. The method according to claim 1, wherein said at least one group of N-grams is formed from N-grams of said plurality of N-grams that are conditioned on the same (N−1)-tuple of preceding words.

3. The method according to claim 1, wherein said compressed representation of said sorted N-gram probabilities is a sampled representation of said sorted N-gram probabilities.

4. The method according to claim 3, wherein said sampled representation of said sorted N-gram probabilities is a logarithmically sampled representation of said sorted N-gram probabilities.

5. The method according to claim 1, wherein said compressed representation of said sorted N-gram probabilities comprises an index into a codebook that comprises a plurality of indexed sets of probability values.

6. The method according to claim 5, wherein a number of said indexed sets of probability values comprised in said codebook is smaller than a number of said groups formed from said plurality of N-grams.

7. The method according to claim 5, wherein said language model comprises N-grams of at least two different levels N₁, and N₂, and wherein at least two compressed representations of sorted N-gram probabilities respectively associated with N-grams of different levels comprise indices to said codebook.

8. A software application product, comprising a storage medium having a software application for compressing a language model that comprises a plurality of N-grams and associated N-gram probabilities embodied therein, said software application comprising:
program code for forming at least one group of N-grams from said plurality of N-grams;
program code for sorting N-gram probabilities associated with said N-grams of said at least one group of N-grams; and
program code for determining a compressed representation of said sorted N-gram probabilities.

9. The software application product according to claim 8, wherein said at least one group of N-grams is formed from N-grams of said plurality of N-grams that are conditioned on the same (N−1)-tuple of preceding words.

10. A storage medium for at least partially storing a language model that comprises a plurality of N-grams and associated N-gram probabilities, said storage medium comprising:
a storage location containing a compressed representation of sorted N-gram probabilities associated with N-grams of at least one group of N-grams formed from said plurality of N-grams.

11. The storage medium according to claim 10, wherein said at least one group of N-grams is formed from N-grams of said plurality of N-grams that are conditioned on the same (N−1)-tuple of preceding words.

12. A device for compressing a language model that comprises a plurality of N-grams and associated N-gram probabilities, said device comprising:
means for forming at least one group of N-grams from said plurality of N-grams;
means for sorting N-gram probabilities associated with said N-grams of said at least one group of N-grams; and
means for determining a compressed representation of said sorted N-gram probabilities.

13. The device according to claim 12, wherein said at least one group of N-grams is formed from N-grams of said plurality of N-grams that are conditioned on the same (N−1)-tuple of preceding words.

14. The device according to claim 12, wherein said means for determining a compressed representation of said sorted N-gram probabilities comprises means for sampling said sorted N-gram probabilities.

15. The device according to claim 12, wherein said compressed representation of said sorted N-gram probabilities comprises an index into a codebook that comprises a plurality of indexed sets of probability values.

16. A device for processing data at least partially based on a language model that comprises a plurality of N-grams and associated N-gram probabilities, said device comprising:
a storage medium having a compressed representation of sorted N-gram probabilities associated with N-grams of at least one group of N-grams formed from said plurality of N-grams stored therein; and
means for retrieving at least one of said sorted N-gram probabilities from said compressed representation of sorted N-gram probabilities stored in said storage medium.

17. The device according to claim 16, wherein said at least one group of N-grams is formed from N-grams of said plurality of N-grams that are conditioned on the same (N−1)-tuple of preceding words.

18. The device according to claim 16, wherein said compressed representation of said sorted N-gram probabilities is a sampled representation of said sorted N-gram probabilities.

19. The device according to claim 16, wherein said compressed representation of said sorted N-gram probabilities comprises an index into a codebook that comprises a plurality of indexed sets of probability values.

20. The device according to claim 16, wherein said device is portable communication device.
